(19) United States
(12) Patent Application Publication
(10) Pub. No.: US 2011/0061491 A1
(43) Pub. Date: Mar. 17, 2011

(54) Bearing device for bicycle pedal

(75) Inventor: Hsin Chu Chin, Taichung (TW)

(73) Assignee: TWENTY26INC.

(21) Appl. No.: 12/586,142

(22) Filed: Sep. 17, 2009

(51) Int. Cl. B62M 3/08

(52) U.S. Cl. 74/594.4

(57) ABSTRACT

A bicycle pedal includes a tubular member having a compartment formed in an inner end portion for engaging with a cartridge, and having an inner peripheral shoulder formed in an outer end portion for engaging with another cartridge, a pedal member engaged onto the tubular member, and a pedal shaft engaged into the tubular member and engaged with the cartridges for rotatably attaching the pedal shaft to the tubular member and for suitably centering the pedal shaft in the pedal member, and the pedal shaft includes an outer thread formed in an outer end portion for engaging with a fastener which rotatably secures the pedal shaft to the tubular member.

### BACKGROUND OF THE INVENTION

1. Field of the Invention

The present invention relates to a bicycle pedal, and more particularly to a bicycle pedal including a tubular member for smoothly attaching or coupling or securing a pedal member onto a pedal shaft and for suitably centering the pedal member and for preventing the pedal member from being easily damaged.

2. Description of the Prior Art

Typical bicycle pedals comprise a pedal member including a central tube member, and a pedal shaft rotatably engaged through the central tube member and secured to the central tube member with fasteners or retaining rings.

For example, U.S. Pat. No. 3,561,289 to Baginski discloses one of the typical bicycle pedals comprising a pedal body member supported on a pedal axle and a plastic bearing member which may be used to rotatably support the pedal body member on the pedal axle.

However, the pedal body member and the plastic bearing member are rotatably secured to the pedal axle with the plastic bearing member and the retaining ring, and the plastic bearing member may have a good chance to be disengaged from the pedal axle after use, and the plastic bearing member may have a good chance to be worn out after use such that the plastic bearing member may have a good chance to be tilted relative to the pedal axle after use.

U.S. Pat. No. 3,592,076 to Baginski discloses another typical bicycle pedal comprising a pedal axle rotatably engaged through the central aperture of a pedal body member with plastic bearing members.

However, the plastic bearing members may have a good chance to be worn out after use such that the pedal body member may have a good chance to be tilted relative to the pedal axle after use and may have a good chance to be disengaged from the pedal axle after use.

U.S. Pat. No. 4,445,397 to Shimano discloses a further typical bicycle pedal comprising a pedal shaft rotatably engaged through the central aperture of a pedal body member with bearing members.

However, the pedal body member may not be suitably centered relative to the pedal shaft after use and may have a good chance to be tilted relative to the pedal shaft after use.

U.S. Pat. No. 4,651,590 to Thun, U.S. Pat. No. 4,838,115 to Nagano, and U.S. Pat. No. 4,840,085 to Nagano disclose three further typical bicycle pedals each also comprising a pedal shaft rotatably engaged through the central aperture of a pedal body member with bearing members and bearing tubes or bushes or ring members.

However, similarly, the pedal body member also may not be suitably centered relative to the pedal shaft after use and may have a good chance to be inclined or tilted relative to the pedal shaft after use.

The present invention has arisen to mitigate and/or obviate the afore-described disadvantages of the conventional foot pedals for the bicycles.

### SUMMARY OF THE INVENTION

The primary objective of the present invention is to provide a bicycle pedal including a tubular member for smoothly attaching or coupling or securing a pedal member onto a pedal shaft and for suitably centering the pedal member and for preventing the pedal member from being easily damaged.

The other objective of the present invention is to provide a bicycle pedal including a pedal member firmly attached onto a pedal shaft for preventing the pedal member from being damaged from the pedal shaft.

In accordance with one aspect of the invention, there is provided a bicycle pedal comprising a tubular member including a bore formed therein, and including a compartment formed in an inner end portion thereof and having an inner diameter greater than that of the bore of the tubular member for forming a first inner peripheral shoulder between the bore and the compartment of the tubular member, the tubular member including a second inner peripheral shoulder formed in an outer end portion thereof, a pedal member engaged onto the tubular member and including an aperture formed therein for receiving the tubular member, a first cartridge engaged in the bore and engaged with the first inner peripheral shoulder of the tubular member, a second cartridge engaged with the second inner peripheral shoulder of the tubular member, and a pedal shaft engaged into the bore of the tubular member and engaged with the first and the second cartridges for rotatably attaching and mounting the pedal shaft to the tubular member, and the pedal shaft includes an outer thread formed in an outer end portion thereof for engaging with a lock nut or fastener which may be engaged with the second cartridge or the tubular member and for rotatably securing the pedal shaft to the tubular member.

The tubular member includes at least one flange provided on an outer peripheral portion thereof, and the pedal member includes at least one rib extended into the aperture of the pedal member and engaged with the rib of the pedal member for stably anchoring the tubular member in the aperture of the pedal member and for preventing the tubular member from being rotated relative to the pedal member.

The tubular member includes an enlarged head provided on the inner end portion thereof and having an outer diameter greater than that of the tubular member for forming an outer peripheral shoulder between the head and the tubular member and for engaging with the pedal member.

The pedal member includes an inner peripheral shoulder formed in an inner portion thereof and engaged with the outer peripheral shoulder of the tubular member and for anchoring the tubular member in the aperture of the pedal member.

A dust cap may further be provided and engaged onto the pedal shaft and engaged with the pedal shaft and engaged with the inner end portion of the tubular member for shielding the first cartridge. A cover may further be provided and engaged onto the outer end portion of the tubular member for shielding the bore of the tubular member.

The pedal shaft includes an enlarged protrusion extended radially and outwardly from an inner end portion thereof for forming a peripheral shoulder between the protrusion and the pedal shaft and for engaging with the dust cap.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a bicycle pedal in accordance with the present invention;

FIG. 2 is a top plan schematic view of the bicycle pedal; and

FIG. 3 is a cross sectional view of the bicycle pedal taken along lines 3-3 of FIG. 2; illustrating the operation of the bicycle pedal.

### DETAILED DESCRIPTION OF THE PREFERRED EMBODIMENT

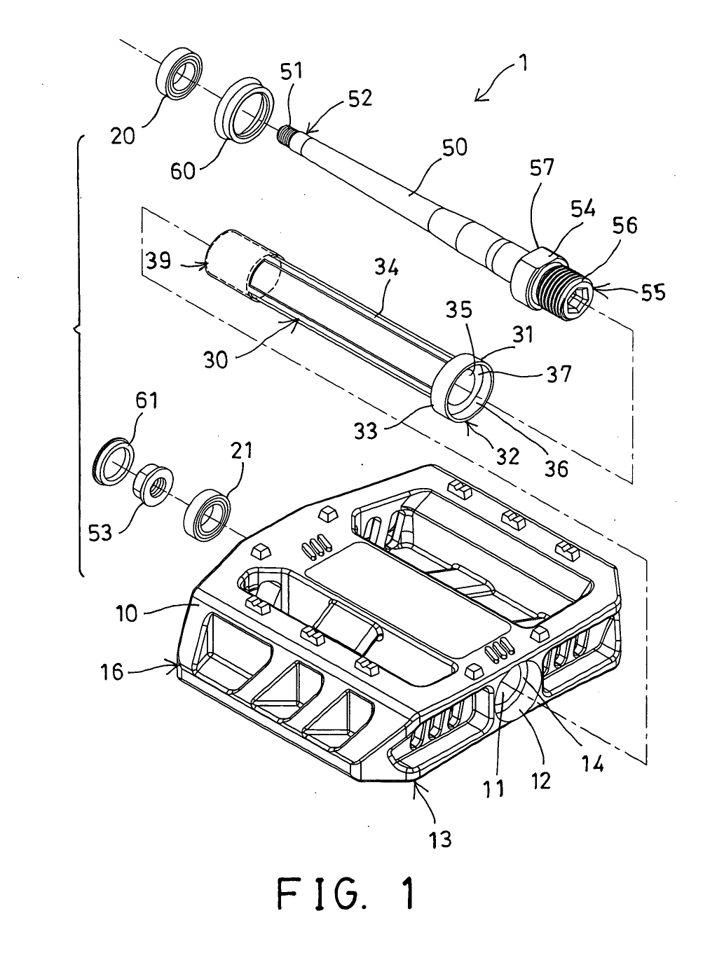

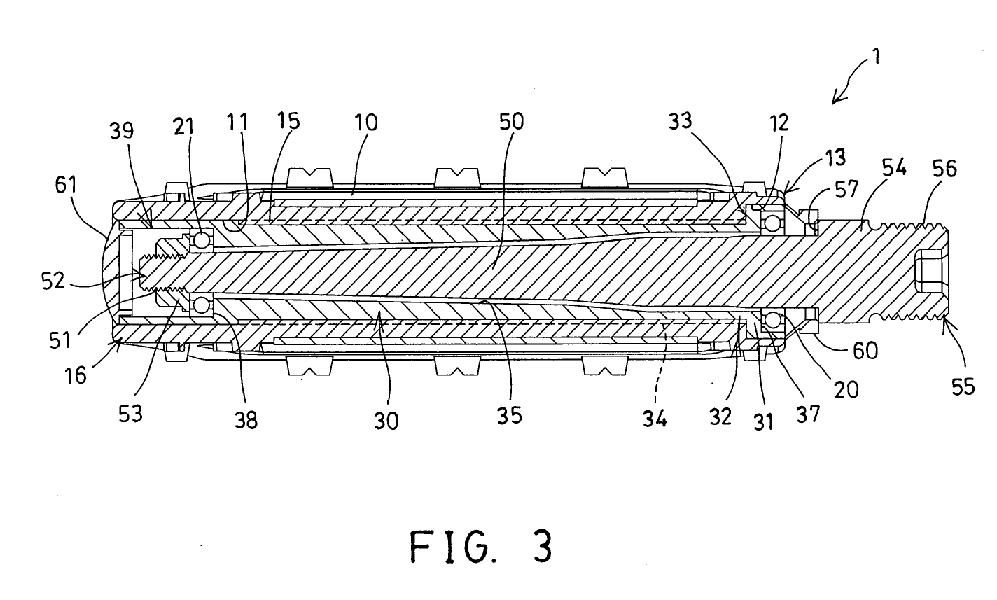

Referring to the drawings, and initially to FIGS. 1 and 3, a bicycle pedal 1 in accordance with the present invention comprises a pedal body member 10 including a chamber or aperture 11 longitudinally formed therein, and including an enlarged opening 12 formed in the one end or inner portion 13 thereof and having an inner diameter greater than that of the aperture 11 of the pedal body member 10 for forming an inner peripheral shoulder 14 between the aperture 11 and the enlarged opening 12 of the pedal member 10 (FIG. 1), and including one or more longitudinal ribs 15 (FIG. 3) longitudinally extended into the aperture 11 of the pedal member 10 and equally spaced from each other.

A tubular member 30 is engaged into or through the aperture 11 of the pedal member 10, or relatively, the pedal member 10 is attached or secured or engaged onto the tubular member 30, and the tubular member 30 includes an enlarged head 31 formed or provided on the one end or inner end portion 32 thereof and having an outer diameter greater than that of the tubular member 30 for forming an outer peripheral shoulder 33 between the head 31 and the tubular member 30 and for engaging with the inner peripheral shoulder 14 of the pedal member 10 and for solidly or stably anchoring or securing the tubular member 30 in the aperture 11 of the pedal member 10, and for reinforcing the inner portion of the pedal member 10.

The tubular member 30 includes one or more longitudinal flanges 34 formed or provided on the outer peripheral portion thereof for engaging with the longitudinal ribs 15 of the pedal member 10 and for stably anchoring or securing the tubular member 30 in the aperture 11 of the pedal member 10, and for preventing the tubular member 30 from being rotated relative to the pedal member 10. For example, the pedal member 10 may be made of plastic, carbon fiber, or other synthetic materials and molded onto the tubular member 30 for forming the ribs 15 of the pedal member 10 and for engaging with the flanges 34 of the tubular member 30. The tubular member 30 includes a bore 35 longitudinally formed therein, and includes an enlarged compartment 36 formed in the head 31 or formed in the inner end portion 32 thereof and having an inner diameter greater than that of the bore 35 of the tubular member 30 for forming an inner peripheral shoulder 37 between the bore 35 and the enlarged compartment 36 of the tubular member 30, and for receiving or engaging with a cartridge 20.

The tubular member 30 further includes another inner peripheral shoulder 38 formed in the other end portion 39 of the tubular member 30 for receiving or engaging with another cartridge 21, and for stably receiving or anchoring or securing or retaining the cartridges 20, 21 within the enlarged compartment 36 and the inner peripheral shoulder 38 of the tubular member 30 respectively. A pedal shaft 50 is engaged into or through the bore 35 of the tubular member 30 and engaged with the cartridges 20, 21 for rotatably attaching or mounting or securing the pedal shaft 50 to the tubular member 30 and then to the pedal member 10.

The pedal shaft 50 includes an outer thread 51 formed in the one end or outer end portion 52 thereof for engaging with a lock nut or fastener 53 which is engaged with the cartridge 21 and for rotatably and stably securing the pedal shaft 50 to the tubular member 30. It is to be noted that the tubular member 30 includes a one-integral-piece preferably made of metal or plastic or other strong materials for suitably reinforcing the pedal member 10 and for allowing the pedal shaft 50 to be solidly and stably attached or secured to the pedal member 10 with the tubular member 30 and the cartridges 20, 21 and for suitably centering the pedal shaft 50 in the pedal member 10.

The pedal shaft 50 includes an enlarged flange or protrusion 54 extended radially and outwardly from the other or inner end portion 55 thereof for forming a peripheral shoulder 57 between the protrusion 54 and the pedal shaft 50, and an annular ring or dust cap 60 is engaged onto the pedal shaft 50 and engaged with the protrusion 54 of the pedal shaft 50 and the cartridge 20 or the inner end portion 32 of the tubular member 30 or the inner portion 13 of the pedal member 10 for covering or shielding the space between the pedal shaft 50 and the cartridge 20 or the inner end portion 32 of the tubular member 30 or the inner portion 13 of the pedal member 10 and for preventing dust or dirt from entering into the space between the pedal shaft 50 and the cartridge 20 or the tubular member 30 and for preventing the cartridge 20 from being damaged by the dust or dirt.

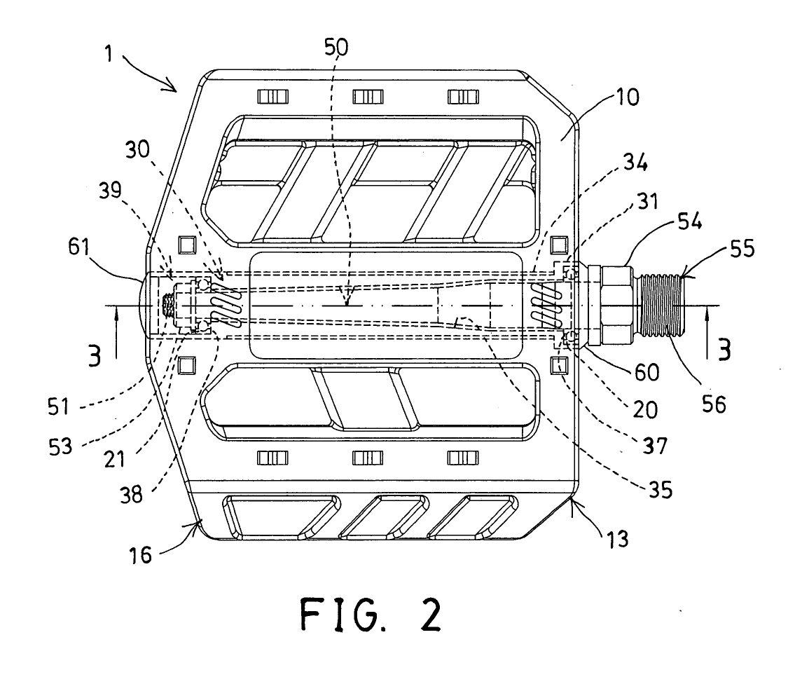

The pedal shaft 50 further includes an outer thread 56 formed in the other or inner end portion 55 thereof for engaging with the cranks of the bicycles (not shown) and for attaching or coupling or securing the pedal shaft 50 to the cranks of the bicycles. As shown in FIGS. 2 and 3, the outer end portion 52 of the pedal shaft 50 and the lock nut or fastener 53 are preferably disposed or located or engaged in the bore 35 of the tubular member 30, and are not extended out of the tubular member 30, and another dust cap or cover 61 is attached to the other end portion or the outer portion 16 of the pedal member 10 and/or to the other end portion 39 of the tubular member 30 for covering or shielding the bore 35 of the tubular member 30 and/or the aperture 11 of the pedal member 10 and for preventing dust or dirt from entering into the bore 35 of the tubular member 30 and/or the aperture 11 of the pedal member 10, and for preventing the cartridge 21 from being damaged by the dust or dirt.

In operation, as shown in FIGS. 2 and 3, the tubular member 30 includes a one-integral-piece structure, and the pedal shaft 50 may be solidly and stably attached or secured to the pedal member 10 with the tubular member 30 and the cartridges 20, 21 such that the pedal shaft 50 may be suitably centered in the tubular member 30 and the pedal member 10, the pedal member 10 may be made of plastic, carbon fiber, or other synthetic materials and wrapped and/or formed or molded onto the tubular member 30 for forming the ribs 15 of the pedal member 10 and for engaging with the flanges 34 of the tubular member 30 and for stably anchoring or securing the pedal member 10 onto the tubular member 30 and for preventing the pedal member 10 from being disengaged from the tubular member 30 and the pedal shaft 50.

It is to be noted that the pedal member 10 is preferably made of plastic, carbon fiber, or other synthetic or plastic materials which may be wrapped or molded onto the tubular member 30 for forming the pedal member 10, or the tubular member 30 may be forced or engaged into the pedal member 10 after the pedal member 10 has been molded or formed, and for preventing the pedal member 10 from being damaged by hitting or striking, and for allowing the weight of the bicycle pedal 1 to be suitably reduced.

Accordingly, the bicycle pedal in accordance with the present invention includes a tubular member for smoothly attaching or coupling or securing a pedal member onto a pedal shaft and for suitably centering the pedal member and for preventing the pedal member from being easily damaged, and the pedal member may be firmly attached onto the pedal shaft for preventing the pedal member from being damaged from the pedal shaft.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A bicycle pedal comprising:
a tubular member including a bore formed therein, and including a compartment formed in an inner end portion thereof and having an inner diameter greater than that of said bore of said tubular member for forming a first inner peripheral shoulder between said bore and said compartment of said tubular member, said tubular member including a second inner peripheral shoulder formed in an outer end portion thereof,
a pedal member engaged onto said tubular member and including an aperture formed therein for receiving said tubular member,
a first cartridge engaged in said bore and engaged with said first inner peripheral shoulder of said tubular member,
a second cartridge engaged with said second inner peripheral shoulder of said tubular member, and
a pedal shaft engaged into said bore of said tubular member and engaged with said first and said second cartridges for rotatably attaching and mounting said pedal shaft to said tubular member, and said pedal shaft including an outer thread formed in an outer end portion thereof for engaging with a fastener which is engaged with said second cartridge and for rotatably securing said pedal shaft to said tubular member.

2. The bicycle pedal as claimed in claim 1, wherein said tubular member includes at least one flange provided on an outer peripheral portion thereof, and said pedal member includes at least one rib extended into said aperture of said pedal member and engaged with said at least one rib of said pedal member for anchoring said tubular member in said aperture of said pedal member and for preventing said tubular member from being rotated relative to said pedal member.

3. The bicycle pedal as claimed in claim 1, wherein said tubular member includes an enlarged head provided on said inner end portion thereof and having an outer diameter greater than that of said tubular member for forming an outer peripheral shoulder between said head and said tubular member and for engaging with said pedal member.

4. The bicycle pedal as claimed in claim 3, wherein said pedal member includes an inner peripheral shoulder formed in an inner portion thereof and engaged with said outer peripheral shoulder of said tubular member and for anchoring said tubular member in said aperture of said pedal member.

5. The bicycle pedal as claimed in claim 1, wherein a dust cap is engaged onto said pedal shaft and engaged with said pedal shaft and engaged with said inner end portion of said tubular member for shielding said first cartridge.

6. The bicycle pedal as claimed in claim 5, wherein said pedal shaft includes an enlarged protrusion extended radially and outwardly from an inner end portion thereof for forming a peripheral shoulder between said protrusion and said pedal shaft and for engaging with said dust cap.

7. The bicycle pedal as claimed in claim 1, wherein a cover is engaged onto said outer end portion of said tubular member for shielding said bore of said tubular member.
